(19) United States
(12) Patent Application Publication
(10) Pub. No.: US 2010/0242042 A1
(43) Pub. Date: Sep. 23, 2010

(54) Method and apparatus for scheduling work in a stream-oriented computer system

(76) Inventors: Nikhil Bansal, Yorktown Heights, NY (US); James R. H. Challenger, Garrison, NY (US); Lisa Karen Fleischer, Ossining, NY (US); Kirsten Weale Hildrum, Hawthorne, NY (US); Richard P. King, Scarsdale, NY (US); Deepak Rajan, Fishkill, NY (US); David Tao, Glen Burnie, MD (US); Joel Leonard Wolf, Katonah, NY (US); Kun-Lung Wu, Yorktown Heights, NY (US)

Correspondence Address: TUTUNJIAN & BITETTO, P.C., 20 CROSSWAYS PARK NORTH, SUITE 210, WOODBURY, NY, 11797, US

(21) Appl. No.: 11/374,192

(22) Filed: Mar. 13, 2006

(51) Int. Cl. G06F 9/50

(52) U.S. Cl. 718/104

(57) ABSTRACT

An apparatus and method for scheduling stream-based applications in a distributed computer system includes a scheduler configured to schedule work using three temporal levels. Each temporal level includes a method. A macro method is configured to schedule jobs that will run, in a highest temporal level, in accordance with a plurality of operation constraints to optimize importance of work. A micro method is configured to fractionally allocate, at a medium temporal level, processing elements to processing nodes in the system to react to changing importance of the work. A nano method is configured to revise, at a lowest temporal level, fractional allocations on a continual basis.

### GOVERNMENT RIGHTS

This invention was made with Government support under Contract No.: TIA H98230-04-3-0001 awarded by the U.S. Department of Defense. The Government has certain rights in this invention.

### BACKGROUND

1. Technical Field

The present invention relates generally to scheduling work in a stream-based distributed computer system, and more particularly, to systems and methods for deciding which tasks to perform in a system.

2. Description of the Related Art

Distributed computer systems designed specifically to handle very large-scale stream processing jobs are in their infancy. Several early examples augment relational databases with streaming operations. Distributed stream processing systems are likely to become very common in the relatively near future, and are expected to be employed in highly scalable distributed computer systems to handle complex jobs involving enormous quantities of streaming data.

In particular, systems including tens of thousands of processing nodes able to concurrently support hundreds of thousands of incoming and derived streams may be employed. These systems may have storage subsystems with a capacity of multiple petabytes.

Even at these sizes, streaming systems are expected to be essentially swamped at almost all times. Processors will be nearly fully utilized, and the offered load (in terms of jobs) will far exceed the prodigious processing power capabilities of the systems, and the storage subsystems will be virtually full. Such goals make the design of future systems enormously challenging.

Focusing on the scheduling of work in such a streaming system, it is clear that an effective optimization method is needed to use the system properly. Consider the complexity of the scheduling problem as follows.

Referring to FIG. 1, a conceptual system is depicted for scheduling typical jobs. Each job 1-9 includes one or more alternative directed graphs 12 with nodes 14 and directed arcs 16. For example, job 8 has two alternative implementations, called templates. The nodes correspond to tasks (which may be called processing elements, or PEs), interconnected by directed arcs (streams). The streams may be either primal (incoming) or derived (produced by the PEs). The jobs themselves may be interconnected in complex ways by means of derived streams. For example, jobs 2, 3 and 8 are connected.

Referring to FIG. 2, a typical distributed computer system 11 is shown. Processing nodes 13 (or PNs) are interconnected by a network 19.

One problem includes the scheduling of work in a stream-oriented computer system in a manner which maximizes the overall importance of the work performed. There are no known solutions to this problem. The streams serve as a transport mechanism between the various processing elements doing the work in the system. These connections can be arbitrarily complex. The system is typically overloaded and can include many processing nodes. Importance of the various work items can change frequently and dramatically. Processing elements may perform continual and more traditional work as well.

### SUMMARY

A scheduler preferably needs to perform each of the following functions: (1) decide which jobs to perform in a system; (2) decide, for each such performed job, which template to select; (3) fractionally assign the PEs in those jobs to the PNs. In other words, it should overlay the PEs of the performed jobs onto the PNs of the computer system, and should overlay the streams of those jobs onto the network of the computer system; and (4) attempt to maximize a measure of the utility of the streams produced by those jobs.

The following practical issues make it difficult for a scheduler to provide this functionality effectively. First, the offered load may typically exceed the system capacity by large amounts. Thus all system components, including the PNs, should be made to run at nearly full capacity nearly all the time. A lack of spare capacity means that there is no room for error.

Second, stream-based jobs have a real-time time scale. Only one shot is available at most primal streams, so it is crucial to make the correct decision on which jobs to run. There are multiple step jobs where numerous PEs are interconnected in complex, changeable configurations via bursty streams, just as multiple jobs are glued together. So flow imbalances lead to buffer overflows (and loss of data), or to under utilization of PEs.

Third, one needs the capability of dynamic rebalancing of resources for jobs, because their importance changes frequently and dramatically. For example, discoveries, new and departing queries and the like can cause major shifts in resource allocation. These changes must be made quickly. Primal streams may come and go unpredictably.

Fourth, there will typically be lots of special and critical requirements on the scheduler of such a system, for instance, priority, resource matching, licensing, security, privacy, uniformity, temporal, fixed point and incremental constraints. Fifth, given a system running at near capacity, it is even more important than usual to optimize the proximity of the interconnected PE pairs as well as the distance between PEs and storage. Thus, for example, logically close PEs should be assigned to physically close PNs.

These competing difficulties make the finding of high quality schedules very daunting. There is presently no known prior art describing schedulers meeting these design objectives. It will be apparent to those skilled in the art that no simple heuristic scheduling method will work satisfactorily for stream-based computer systems of this kind. There are simply too many different aspects that need to be balanced against each other.

Accordingly, aspects of the present invention describe a three-level hierarchical method which creates high quality schedules in a distributed stream-based environment. The hierarchy is temporal in nature. As the levels increase, the difficulty in solving the problem also increases. However, more time to solve the problem is provided as well. Furthermore, the solution to a higher level problem makes the next lower level problem more manageable. The three levels, from top to bottom, may be referred to for simplicity as the macro, micro and nano models respectively.

An apparatus and method for scheduling stream-based applications in a distributed computer system includes a scheduler configured to schedule work using different temporal levels. Each temporal level includes a method. A macro method is configured to schedule jobs that will run, in a highest temporal level, in accordance with a plurality of operation constraints to optimize importance of work. A micro method is configured to fractionally allocate, at a medium temporal level, processing elements to processing nodes in the system to react to changing importance of the work. A nano method is configured to revise, at a lowest temporal level, fractional allocations on a continual basis.

A method for scheduling stream-based applications includes providing a scheduler configured to schedule work using three temporal levels, scheduling jobs that will run, in a highest temporal level, in accordance with a plurality of operation constraints to optimize importance of work, fractionally allocating, at a medium temporal level, processing elements to processing nodes in the system to react to changing importance of the work, and revising, at a lowest temporal level, fractional allocations on a continual basis.

Another method for scheduling stream-based applications includes providing a scheduler configured to schedule work using a plurality of temporal levels, scheduling jobs that will run, in a first temporal level, in accordance with a plurality of operation constraints to optimize importance of work, fractionally allocating, at a second temporal level, processing elements to processing nodes in the system to react to changing importance of the work and revising fractional allocations on a continual basis.

An apparatus for scheduling stream-based applications in a distributed computer system includes a scheduler configured to schedule work using a plurality of temporal levels. The temporal levels may include a macro method configured to schedule jobs that will run, in a highest temporal level, in accordance with a plurality of operation constraints to optimize importance of work, and a micro method configured to fractionally allocate, at a temporal level less than the highest temporal level, processing elements to processing nodes in the system to react to changing importance of the work. A nano method may also be included.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 depicts an example of a collection of jobs, including alternative templates, processing elements and streams;

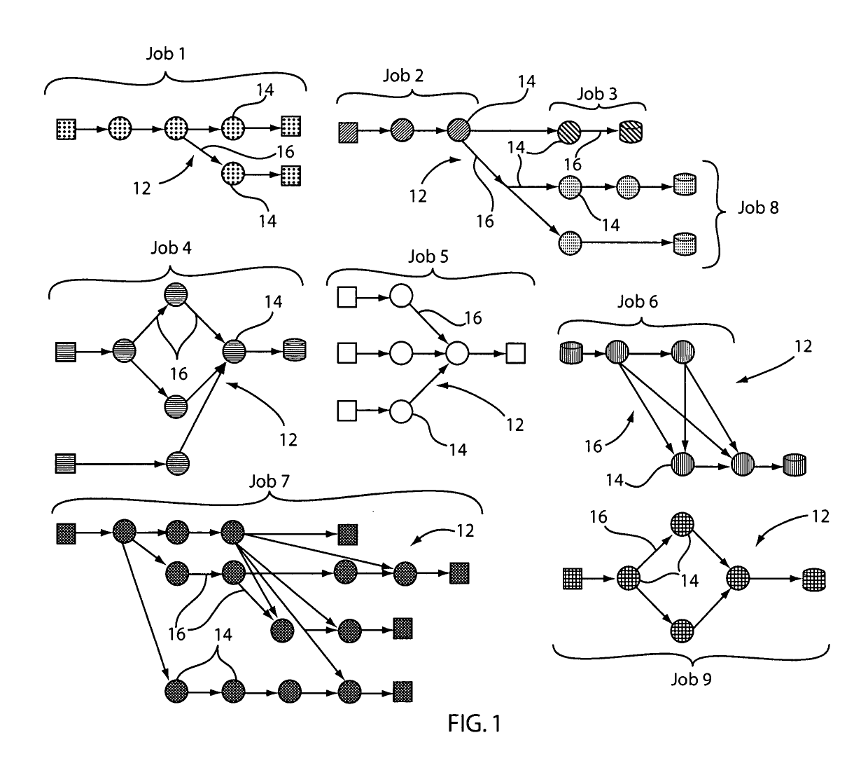

FIG. 2 depicts an example of processing nodes and a network of a distributed stream-based system including switches;

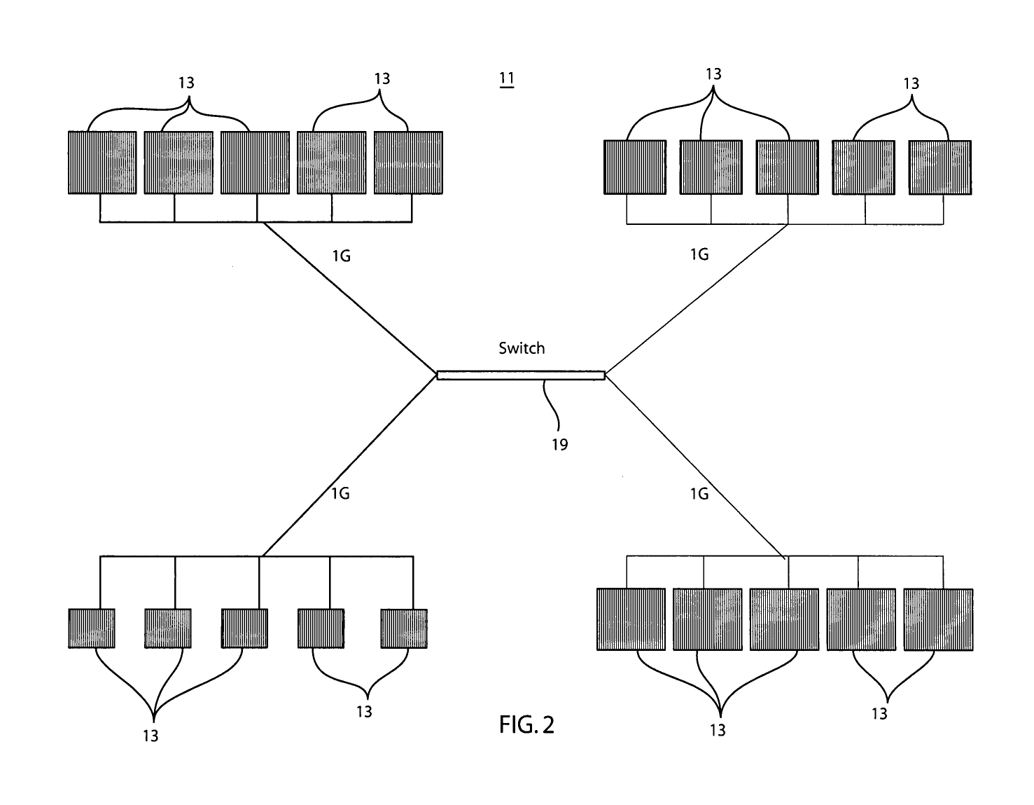

FIG. 3 is a block/flow diagram illustratively showing a scheduler in accordance with one embodiment;

FIG. 4 depicts three distinct temporal levels of the three epoch-based models referred to as macro, micro and nano epochs;

FIG. 5 depicts the decomposition of the macro epoch of FIG. 4 into six component times, including times for an input module, a macroQ module, an optional AQ module, a macroW module, an optional AQW module and an output implementation module;

FIG. 6 is a flowchart describing an illustrative macro model method;

FIG. 7 depicts the decomposition of the micro epoch into its six component times, including times for an input module, a microQ module, an optional δQ module, a microW module, an optional δQW module and an output implementation module; and

FIG. 8 is a flowchart describing an illustrative micro model method.

### DETAILED DESCRIPTION OF PREFERRED EMBODIMENTS

Embodiments of the present invention include a hierarchical scheduler for distributed computer systems particularly useful for stream-based applications. The scheduler attempts to maximize the importance of all work in the system, subject to a large number of constraints of varying importance. The scheduler includes two or more methods and distinct temporal levels. N methods and N layers may be employed in accordance with the embodiments described herein, although 3 layers will be illustratively depicted for demonstrative purposes. More methods and layers may be employed.

In one embodiment, three major methods at three distinct temporal levels are employed. The distinct temporal levels may be referred to as macro, micro and nano models, respectively.

The time unit for the macro model is a macro epoch, e.g., on order of a half hour or an hour. The output of the macro model may include a list of which jobs will run, a choice of one of potentially multiple alternative templates for running the job, and the lists of candidate processing nodes for each processing element that will run.

The time unit for the micro model is a micro epoch, e.g., on order of minutes, approximately one order of magnitude less than a macro epoch. The output may include fractional allocations of processing elements to processing nodes based on the decisions of the macro model. These fractional allocations are preferably flow balanced, at least at the temporal level of a micro epoch. The decisions of the macro model guide and simplify those of the micro model.

The nano model makes decisions every few seconds, e.g., about two orders of magnitude less than a micro epoch. One goal of the nano model is to implement flow balancing decisions of the micro model at a much finer temporal level, dealing with burstiness and the differences between expected and achieved progress. Such issues can lead to flooding of stream buffers and/or starvation of downstream processing elements.

The hierarchical design preferably includes three major optimization schemes at three distinct temporal levels. The basic components of these three levels and the relationships between the three distinct levels are employed by embodiments of the present invention.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A commonly assigned disclosure, filed currently herewith, entitled: METHOD AND APPARATUS FOR ASSIGNING FRACTIONAL PROCESSING NODES TO WORK IN A STREAM-ORIENTED COMPUTER SYSTEM, Attorney Docket Number YOR920050583US1 (163-113) is hereby incorporated by reference. This disclosure described the micro method in greater detail.

A commonly assigned disclosure, filed currently herewith, entitled: METHOD AND APPARATUS FOR ASSIGNING CANDIDATE PROCESSING NODES TO WORK IN A STREAM-ORIENTED COMPUTER SYSTEM, Attorney Docket Number YOR920050584US1 (163-114) is hereby incorporated by reference. This disclosure described the macro method in greater detail.

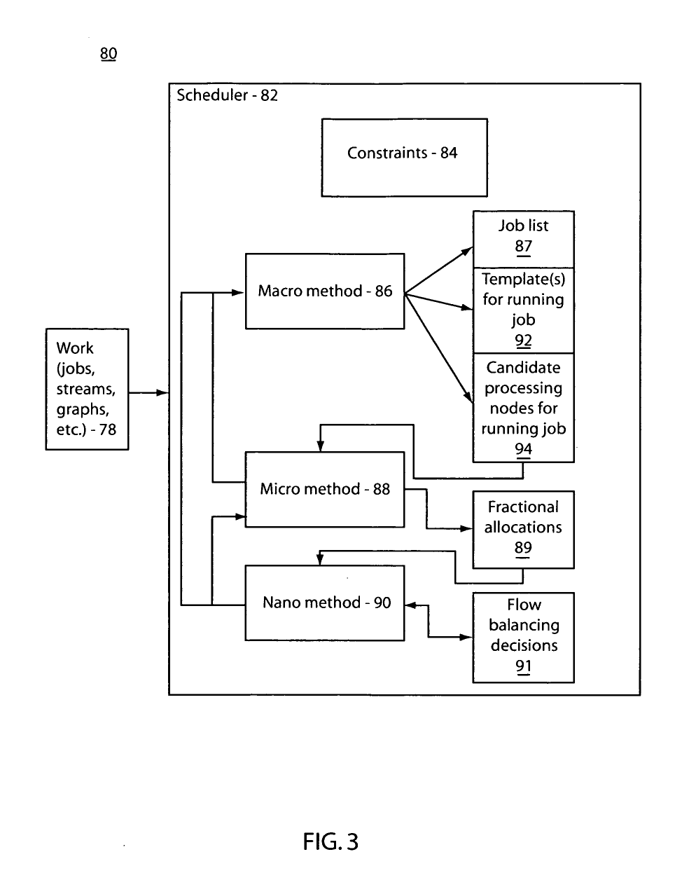

Referring now to the drawings in which like numerals represent the same or similar elements and initially to FIG. 3, a block/flow diagram shows an illustrative system 80. System 80 includes a hierarchically designed scheduler 82 for distributed computer systems designed for stream-based applications. The scheduler 82 attempts to maximize the importance of all work in the system, subject to a large number of constraints 84. The scheduler includes three major methods (or models) at three distinct temporal levels. These are known as the macro 86, micro 88 and nano 90, respectively. The macro model operates in the macro epoch, the micro model in the micro epoch and the nano model in the nano epoch.

The scheduler 82 receives templates, data, graphs, streams or any other schema representing jobs/applications to be performed by system 80. The scheduler 82 employs the constraints and the hierarchical methods to provide a solution to the scheduling problems presented using the three temporal regimes as explained hereinafter.

Beginning with the macro method/model 86, constraints 84 or other criteria are employed to permit the best scheduling of tasks. The macro method 86 performs the most difficult scheduling tasks. The output of the macro model 86 is a list 87 of which jobs will run, a choice of one of potentially multiple alternative templates 92 for running the job, and the lists of candidate processing nodes 94 for each processing element that will run. The output of the micro model 88 includes fractional allocations 89 of processing elements to processing nodes based on the decisions of the macro model 86.

The nano model 90 implements flow balancing decisions 91 of the micro model 88 at a much finer temporal level, dealing with burstiness and the differences between expected and achieved progress.

At a highest temporal level (macro) the jobs that will run, the best template alternative for those jobs that will run, and candidate processing nodes selected for the processing elements of the best template for each running job are provided to maximize the importance of the work performed by the system. At a medium temporal level (micro) fractional allocations and reallocations of processing elements are made to processing nodes in the system to react to changing importance of the work.

At a lowest temporal level (nano), the fractional allocations are revised on a nearly continual basis to react to the burstiness of the work, and to differences between projected and real progress. The steps are repeated through the process. The ability to manage the utilization of time at the highest and medium temporal levels, and the ability to handle new and updated scheduler input data in a timely manner are provided.

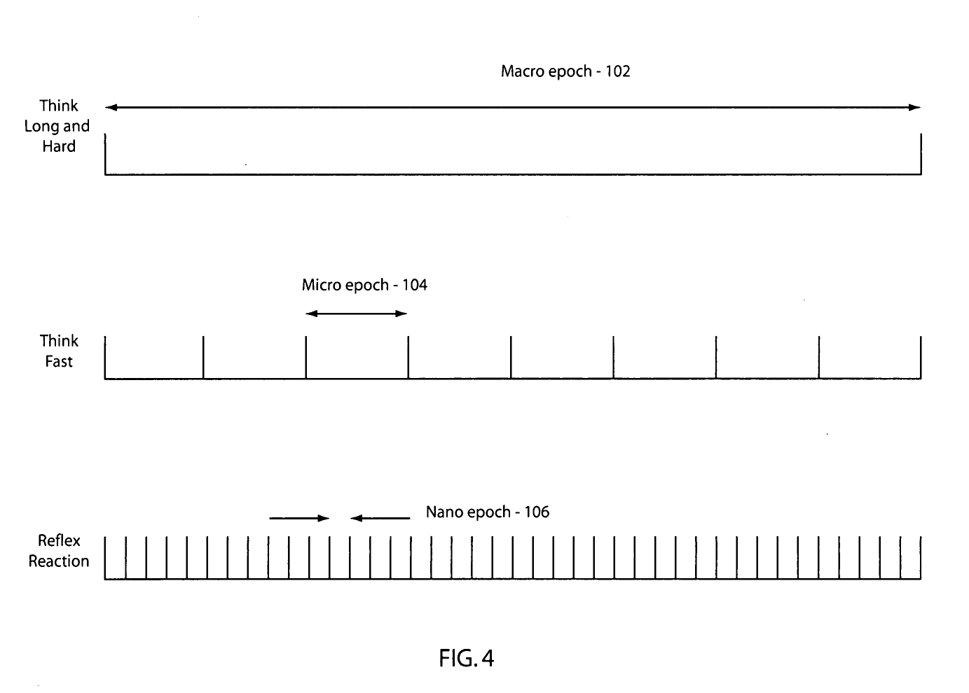

Referring to FIG. 4, three distinct time epochs, and the relationships between three distinct models are illustratively shown. The time epochs include a macro epoch 102, a micro epoch 104 and a nano epoch 106. Note that each macro epoch 102 is composed of multiple micro epochs 104, and that each micro epoch 104 is composed of multiple nano epochs 106. The macro model has sufficient time to “think long and hard” in the macro epoch 102. The micro model only has time to “think fast” in a micro epoch 104. The nano model effectively involves “reflex reactions” in the nano epoch 106 scale.

The scheduling problem is decomposed into these levels (102, 104, 106) because different aspects of the problem need different amounts of think times. Present embodiments more effectively employ resources by solving the scheduling problem with an appropriate amount of resources.

The present disclosure employs a number of new concepts, which are now illustratively introduced.

Value Function: Each derived stream produced by a job will have a value function associated with the stream. This may include an arbitrary real-valued function whose domain is a cross product from a list of metrics such as rate, quality, input stream consumption, input stream age, completion time and so on. The resources assigned to the upstream processing elements (PEs) can be mapped to the domain of this value function via an iterative composition of so-called resource learning functions, one for each derived stream produced by such a PE.

Learning Function: Each resource learning function maps the cross products of the value function domains of each derived stream consumed by the PE with the resource given to that PE into the value function domain of the produced stream.

A value function of 0 is completely acceptable. In particular, it is expected that a majority of intermediate streams will have value functions of 0. Most of the value of the system will generally be placed on the final streams. Nevertheless, the present invention is designed to be completely general with regard to value functions.

Weight: Each derived stream produced by a job will have a weight associated with the stream. This weight may be the sum and product of multiple weight terms. One summand may arise from the job which produces the stream and others may arise from the jobs which consume the stream if the jobs are performed.

Static and Dynamic Terms: Each summand may be the product of a “static” term and a “dynamic” term. The “static” term may change only at weight epochs (on the order of months), while the “dynamic” term may change quite frequently in response to discoveries in the running of the computer system. Weights of 0 are perfectly acceptable and changing weights from any number to 0 facilitate the turning on and off of subjobs. If the value function of a stream is 0, the weight of that stream can be assumed to be 0 as well.

Importance: Each derived stream produced by a job has an importance which is the weighted value. The summation of this importance over all derived streams is the overall importance being produced by the computer system, and this is one quantity that the present embodiments attempt to optimize.

Priority Number: Each job in the computer system has a priority number which is effectively used to determine whether the job should be run at some positive level of resource consumption. The importance, on the other hand, determines the amount of resources to be allocated to each job that will be run.

The above defined quantities may be employed as constraints used in solving the scheduling problem. Comparison or requirements regarding each may be employed by one skilled in the art to determine a best solution for a given scheduling problem.

Turning again to FIG. 3, the macro model 86 makes the micro model 88 more effective by permitting the micro model 88 to robustly and quickly react to dynamic changes by choosing the candidate processing nodes (PNs) to which a PE may be allocated, allowing preparation of those PNs in advance, pre-solving to accommodate pacing and minimize network traffic, finding solutions which automatically respect resource matching, licensing, security, privacy, uniformity, temporal constraints, and increasing assignment flexibility, among other things.

The macro model 86 does the “heavy lifting” in the optimizer. The macro model 86 thinks about very hard problems, the output of which makes the job of the micro model 88 vastly more achievable.

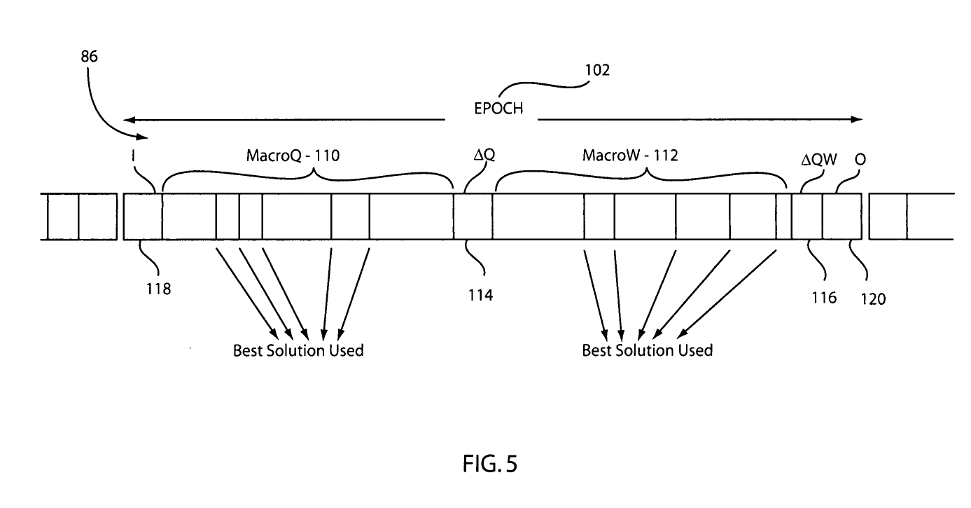

Referring to FIG. 5, an overview of a macro model 86 illustrates the manner in which the macro model is decoupled. There are two sequential methods 110 and 112 (MacroQ and MacroW), plus an input module 118 (I) and an output implementation module 120 (O). There are also two optional ‘Δ’ models 114 and 116 (ΔQ and ΔQW), which permit updates and/or corrections in the input data for the two sequential methods 110 and 112, by revising the output of these two methods incrementally to accommodate the changes.

The present embodiment describes the two decoupled sequential methods below: MacroQ is the ‘quantity’ component of the macro model. It maximizes projected importance by deciding which jobs to do, by choosing a template for each job that is done, and by computing flow balanced PE processing allocation goals, subject to job priority constraints. Present embodiments are based on a combination of dynamic programming, non-serial dynamic programming, and other resource allocation problem techniques.

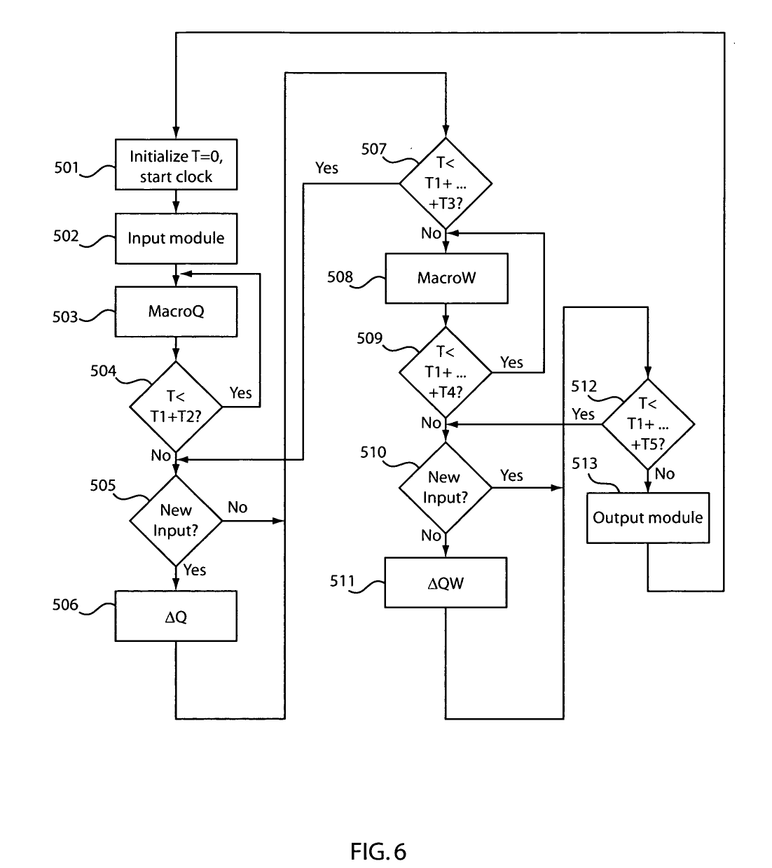

MacroW is the ‘where’ component of the macro model. It minimizes projected network traffic by uniformly overprovisioning nodes to PEs based on the goals given to it by the macroQ component, all subject to incremental, resource matching, licensing, security, privacy, uniformity, temporal and other constraints. Embodiments are based on a combination of binary integer programming, mixed integer programming and heuristic techniques. The decoupling of the macro components in FIG. 5 is further described in FIG. 6.

Referring to FIG. 6 with continued reference to FIG. 5, a flow/block diagram illustratively shows an exemplary embodiment for managing the hierarchy described in FIG. 5. In one preferred embodiment, the macro epoch is subdivided into smaller time lengths, e.g., 6 time lengths, T1, T2, T3, T4, T5 and T6. T1 is the time needed by the input module, I (118). T2 is the time allotted to the macroQ component (110). T3 is the time needed by the optional ΔQ module (114). (This model incrementally adjusts the output of macroQ to data that arrives or is changed subsequent to the beginning of the macroQ module. If this module is not used, T3 is set to 0.) T4 is the time allotted to the macroW component (112). T5 is the time needed by the optional ΔQW module (116). (This model incrementally adjusts the output of macroQ and macroW to data that arrives or is changed subsequent to the beginning of the macroW module. If this module is not used, T5 is set to 0.) T6 is the time needed by the output implementation module, O (120). The total, T1+T2+T3+T4+T5+T6, is equal to the length of the macro epoch.

In block 501, the elapsed time T is set to 0 and the clock is initiated. (Such timers are available in computer systems.) In block 502, the input module (I) provides the necessary data to the macroQ component. In block 503, the macroQ component runs and produces output in its next iteration. Block 504 checks to see if the elapsed time T is less than T1+T2. If the elapsed time is less, the method returns to block 503. If not the method outputs the best solution to macroQ that has been found in the various iterations, and continues with block 505.

Block 505 checks to see if new input data has arrived. If it has, the ΔQ module is invoked in block 506. If no new data has arrived in block 505, block 507 checks to see if T is less than T1+T2+T3. If T is less, the method returns to block 505. If not, the method continues with block 508, taking the output of the last iteration and improving on it as time permits.

In block 508, the macroW component runs and produces output in its next iteration. Block 509 checks to see if the elapsed time T is less than T1+T2+T3+T4. If the elapsed time is less, the method returns to block 508. If not, the method outputs the best solution to macroW that has been found in the various iterations, and continues with block 510. In one embodiment, the best solution will be (a) a choice of which jobs to execute which maximizes the importance of the work done in the system subject to priority constraints, (b) for those jobs that are done, a choice which template among a set of given alternatives which optimizes the tradeoff between work and used resources, and (c) for each PE in the templates used for the jobs that are done, a choice of which processing nodes will be candidates for processing the PE which minimizes the network traffic used subject to licensing, security and other constraints.

Block 510 checks to see if new input data has arrived. If it has, the ΔQW module is invoked in block 511. If no new data has arrived in block 510, block 512 checks to see if T is less than T1+T2+T3+T4+T5. If T is less, the method returns to block 510. If not, the method outputs its results in block 513. Then, the method continues for a new macro epoch, starting back at block 501.

Micro Model: The micro model handles dynamic variability in the relative importance of work (e.g., via revised “weights”), changes in the state of the system, changes in the job lists, changes in the job stages, without having to consider the difficult constraints handled in the macro model.

The micro model exhibits the right balance between problem design and difficulty, as a result of the output from macro model. The micro model is flexible enough to deal with dynamic variability in importance and other changes, also due to the “heavy lifting” in the macro model. Here “heavy lifting” means that the micro model will not have to deal with the issues of deciding which jobs to run and which templates to choose because the macro model has already done this. Thus, in particular, the difficulties associated with maximizing importance and minimizing networks subject to a variety of difficult constraints has already been dealt with, and the micro model need not deal further with these issues. “Heavy lifting” also means that the micro model will be robust with respect to dynamic changes in relative importance and other dynamic issues, because the macro model has provided a candidate processing node solution which is specifically designed to robustly handle such dynamic changes to the largest extent possible.

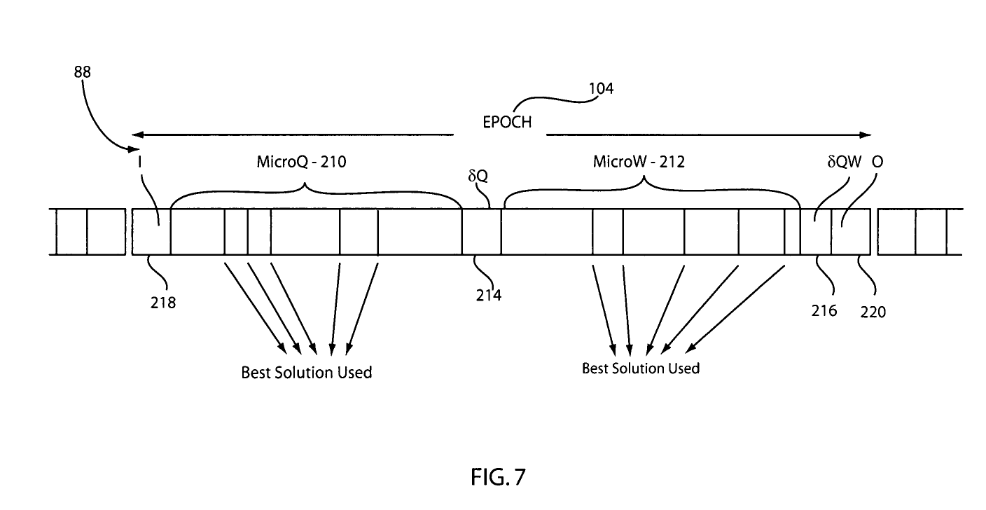

Referring to FIG. 7, the manner in which the micro model 88 is decoupled is illustratively demonstrated. There are two sequential methods 210 and 212, plus an input module (I) 218 and an output implementation module (O) 220. There are also two optional ‘Δ’ models, δQ 210 and δQW 212, which permit for updates and/or corrections in the input data for the two sequential methods 210 and 212, by revising the output of these two methods incrementally to accommodate changes, e.g., if the data has been updated during the processing of the earlier data, etc.). The present embodiment describes the two decoupled sequential methods below.

MicroQ 210 is the ‘quantity’ component of the micro model 88. MicroQ 210 maximizes real importance by revising the allocation goals to handle changes in weights, changes in jobs, and changes in node states. Aspects of the present invention employ a combination of the network flow and linear programming (LP) techniques.

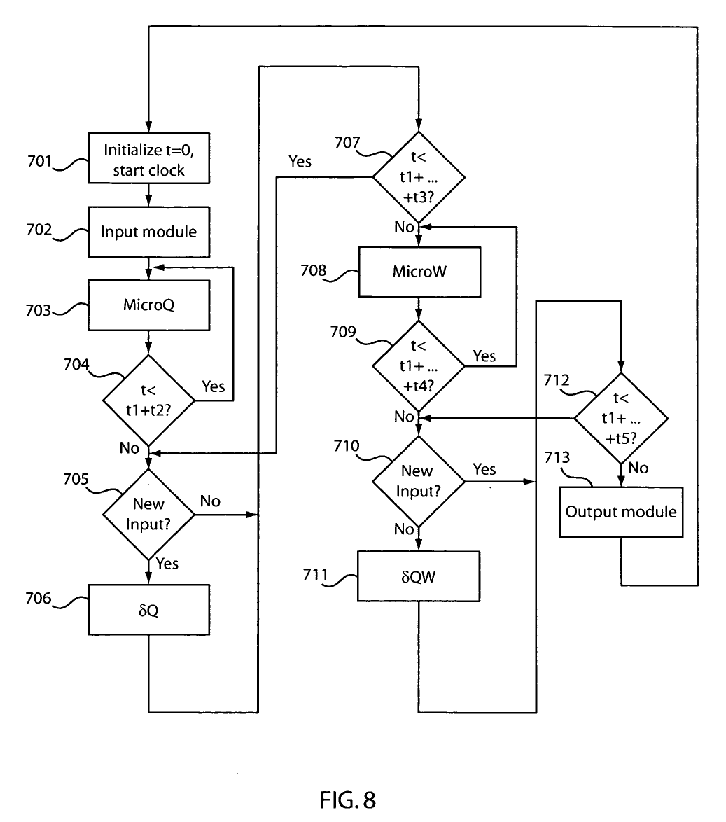

MicroW 212 is the ‘where’ component of the micro model 88. MicroW 212 minimizes the differences between the goals output by the microQ module and the achieved allocations, subject to incremental, provisioning, and node state constraints. Aspects of the present invention employ network flow inspired and other heuristic techniques. The decoupling of the macro components in FIG. 7 is further described in FIG. 8.

Referring to FIG. 8 with continued reference to FIG. 7, in one preferred embodiment, the micro epoch 104 is subdivided into 6 smaller time lengths, t1, t2, t3, t4, t5, and t6. t1 is the time needed by the input module (218). t2 is the time allotted to the microQ component (210). t3 is the time needed by the optional δQ module (214). (This model incrementally adjusts the output of microQ to data that arrives or is changed subsequent to the beginning of the microQ module. If this module is not used, t3 is set to 0.) t4 is the time allotted to the microW component (212). t5 is the time needed by the optional δQW module (216). (This model incrementally adjusts the output of microQ and microW to data that arrives or is changed subsequent to the beginning of the microW module. If this module is not used, t5 is set to 0.) t6 is the time needed by the output implementation module (220). The total t1+t2+t3+t4+t5+t6 is equal to the length of the micro epoch 104.

In block 701, the elapsed time t is set to 0 and the clock is initiated. (Such timers are available in computer systems.) In block 702, the input module (I) provides the necessary data to the microQ component. In block 703, the microQ component runs and produces output in its next iteration. Block 704 checks to see if the elapsed time t is less than t1+t2. If it is, the method returns to block 703. If not the method outputs the best solution to microQ that has been found in the various iterations, and continues with block 705.

Block 705 checks to see if new input data has arrived. If it has, the δQ module is invoked in block 706. If no new data has arrived in block 705, block 707 checks to see if t is less than t1+t2+t3. If t is less, the method returns to block 705. If not, the method continues with block 708. In block 708, the microW component runs and produces output in its next iteration.

Block 709 checks to see if the elapsed time t is less than t1+t2+t3+t4. If t is less, the method returns to block 708. If not, the method outputs the best solution that has been found in the various iterations to microW, and continues with block 710. Block 710 checks to see if new input data has arrived. If it has, the δQW module is invoked in block 711. If no new data has arrived in block 710, block 712 checks to see if t is less than t1+t2+t3+t4+t5. If t is less, the method returns to block 710. If not, the method outputs its results in block 713. The method continues for a new micro epoch, starting back at block 701.

Nano Model: The nano model balances flow to handle variations in expected versus achieved progress. It exhibits a balance between problem design and hardness, as a result of output from the micro model. At the nano level, revising the fractional allocations and reallocations of the micro model on a continual basis is performed to react to burstiness of the work, and to differences between projected and real progress.

Having described preferred embodiments of a method and apparatus for scheduling work in a stream-oriented computer system (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method of scheduling stream-based applications in a distributed computer system, comprising:
choosing, at a highest temporal level, jobs that will run, a best template alternative for the jobs that will run, and candidate processing nodes for processing elements of the best template for each running job to maximize importance of work performed by the system;
making, at a medium temporal level, fractional allocations and reallocations of processing elements to processing nodes in the system to react to changing importance of the work; and
revising, at a lowest temporal level, the fractional allocations and reallocations on a continual basis.

2. The method as recited in claim 1, further comprising repeating one or more of choosing, making and revising to schedule the work.

3. The method as recited in claim 1, further comprising managing utilization of time at the highest and medium temporal levels by comparing an elapsed time with time needed for one or more processing modules.

4. The method as recited in claim 1, further comprising handling new and updated input data to adjust scheduling of work.

5. A computer program product comprising a computer useable medium having a computer readable program, wherein the computer readable program when executed on a computer causes the computer to execute the method of claim 1.

6. A method for scheduling stream-based applications, comprising:
providing a scheduler configured to schedule work using three temporal levels;
scheduling jobs that will run, in a highest temporal level, in accordance with a plurality of operation constraints to optimize importance of work;
fractionally allocating, at a medium temporal level, processing elements to processing nodes in the system to react to changing importance of the work; and
revising, at a lowest temporal level, fractional allocations on a continual basis.

7. The method as recited in claim 6, further comprising repeating one or more of scheduling, allocating and revising to schedule the work.

8. The method as recited in claim 6, further comprising managing utilization of time at the highest and medium temporal levels by comparing an elapsed time with time needed for one or more processing modules.

9. The method as recited in claim 6, further comprising handling new and updated input data to adjust scheduling of work.

10. A computer program product comprising a computer useable medium having a computer readable program, wherein the computer readable program when executed on a computer causes the computer to execute the method of claim 6.

11. A method for scheduling stream-based applications, comprising:
providing a scheduler configured to schedule work using a plurality of temporal levels;
scheduling jobs that will run, in a first temporal level, in accordance with a plurality of operation constraints to optimize importance of work;
fractionally allocating, at a second temporal level, processing elements to processing nodes in the system to react to changing importance of the work; and
revising fractional allocations on a continual basis.

12. An apparatus for scheduling stream-based applications in a distributed computer system, comprising:
a scheduler configured to schedule work using a plurality of temporal levels including:
a macro method configured to schedule jobs that will run, in a highest temporal level, in accordance with a plurality of operation constraints to optimize importance of work; and
a micro method configured to fractionally allocate, at a temporal level less than the highest temporal level, processing elements to processing nodes in the system to react to changing importance of the work.

13. The apparatus as recited in claim 12, wherein the macro method includes a quantity component configured to maximize importance by deciding which jobs to do, by choosing a template for each job that is done, and by computing flow balanced processing element processing allocation goals, subject to job priority constraints.

14. The apparatus as recited in claim 13, wherein the macro method includes a where component configured to minimizes projected network traffic by uniformly overprovisioning nodes to processing elements based on the goals given by the quantity component, subject to constraints.

15. The apparatus as recited in claim 13, wherein the macro method includes an input module and an output module, and delta models which permit updates and corrections in input data for the quantity and where components.

16. The apparatus as recited in claim 12, wherein the micro method includes a quantity component configured to maximize real importance by revising allocation goals to handle changes in weights of jobs, changes in jobs, and changes in node states.

17. The apparatus as recited in claim 16, wherein the micro method includes a where component configured to minimize differences between goals output by the quantity component and achieved allocations.

18. The apparatus as recited in claim 17, wherein the micro method includes an input module and an output module, and delta models which permit updates and corrections in input data for the quantity and where components.

19. The apparatus as recited in claim 12, further comprising:
a nano method configured to revise, at a lowest temporal level, fractional allocations on a continual basis to react to burstiness of the work, and to differences between projected and real progress.

20. The apparatus as recited in claim 12, wherein the scheduler includes an ability to handle new and updated input data.
